(19) United States
(12) Patent Application Publication
(10) Pub. No.: US 2014/0122930 A1
(43) Pub. Date: May 1, 2014

(54) PERFORMING DIAGNOSTIC TESTS IN A DATA CENTER

(71) Applicant: INTERNATIONAL BUSINESS MACHINES CORP, ARMONK, NY (US)

(72) Inventors: SANTOSH DEVALE, DAVANGERE (IN); RAJAT Y. JOSHI, BANGALORE (IN); VISHAL KULKARNI, BANGALORE (IN); VENKATESH SAINATH, BANGALORE (IN)

(73) Assignee: INTERNATIONAL BUSINESS MACHINES CORPORATION, ARMONK, NY (US)

(21) Appl. No.: 13/660,555

(22) Filed: Oct. 25, 2012

(51) Int. Cl. G06F 11/34

(52) U.S. Cl. 714/37; 714/E11.189

(57) ABSTRACT

Diagnostic tests are performed in a data center that includes servers of various types and a management console, where each server provides an error log in a format specific to the type of the server. The management console receives an error log indicating an error produced by a hardware component, parses the error log into an error notification that describes the error and a type of the hardware component, and provides the error notification to other servers. Each of the other servers determines whether the server includes a hardware component of the same type, and if so, performs one or more diagnostic tests on the hardware component and reports results of the diagnostic tests to the management console.

### BACKGROUND OF THE INVENTION

1. Field of the Invention

The field of the invention is data processing, or, more specifically, methods, apparatus, and products for performing diagnostic tests in a data center.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Cloud computing and cloud-based environments are steadily becoming more prevalent. Cloud-based environments provide a user the power of many computers through by accessing the powerful computers through a much less powerful single computer. Such powerful computers are typically housed in one or more data centers and remotely accessible by the user. Data centers today may contain hundreds or thousands of servers. Some data centers contain a heterogeneous mix of systems from various vendors. For example, data centers may contain servers with x86 processor architectures, servers with Power™ processor architectures, and so on. Further, hardware components may vary from one server to the next in a data center. When errors occur in servers of such a data center, errors are typically reported to a management console. The management console aggregates multiple error reports, identifies similarities among the multiple error reports, and identifies possible root causes. Using the possible root causes, a system administrator may mitigate future errors in the data center. In such a data center, however, multiple errors must be aggregated before mitigation can occur.

### SUMMARY

Methods, apparatus, and products for performing diagnostic tests in a data center are disclosed in this specification. The data center includes a plurality of servers and a management console. The plurality of servers comprises two or more different types of servers. Each server is configured to report errors to the management console in an error log format specific to the type of the server reporting the error log. Performing diagnostic tests in such a data center includes: receiving, by the management console from an error generating server, an error log indicating an error produced by a hardware component of the error generating server; parsing, by the management console, the error log into an error notification, the error notification including information describing the error and a type of the hardware component producing the error in the error generating server; and providing, by the management console to a plurality of other servers, the error notification.

For each of the other servers receiving the error notification, the other server determines whether the server includes a hardware component having the same hardware component type included in the error notification. If the other server includes a hardware component having the same hardware component type included in the error notification, the other server performs one or more diagnostic tests on the hardware component of the server; and reports, by the other server, results of the diagnostic tests to the management console.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of a system for performing diagnostic tests in a data center according to embodiments of the present invention.

FIG. 2 sets forth a flow chart illustrating an exemplary method for performing diagnostic tests in a data center according to embodiments of the present invention.

FIG. 3 sets forth a flow chart illustrating a further exemplary method for performing diagnostic tests in a data center according to embodiments of the present invention.

FIG. 4 sets forth a flow chart illustrating a further exemplary method for performing diagnostic tests in a data center according to embodiments of the present invention.

FIG. 5 sets forth a flow chart illustrating a further exemplary method for performing diagnostic tests in a data center according to embodiments of the present invention.

FIG. 6 sets forth a flow chart illustrating a further exemplary method for performing diagnostic tests in a data center according to embodiments of the present invention.

FIG. 7 sets forth a flow chart illustrating a further exemplary method for performing diagnostic tests in a data center according to embodiments of the present invention.

FIG. 8 sets forth a flow chart illustrating a further exemplary method for performing diagnostic tests in a data center according to embodiments of the present invention.

### DETAILED DESCRIPTION OF EXEMPLARY EMBODIMENTS

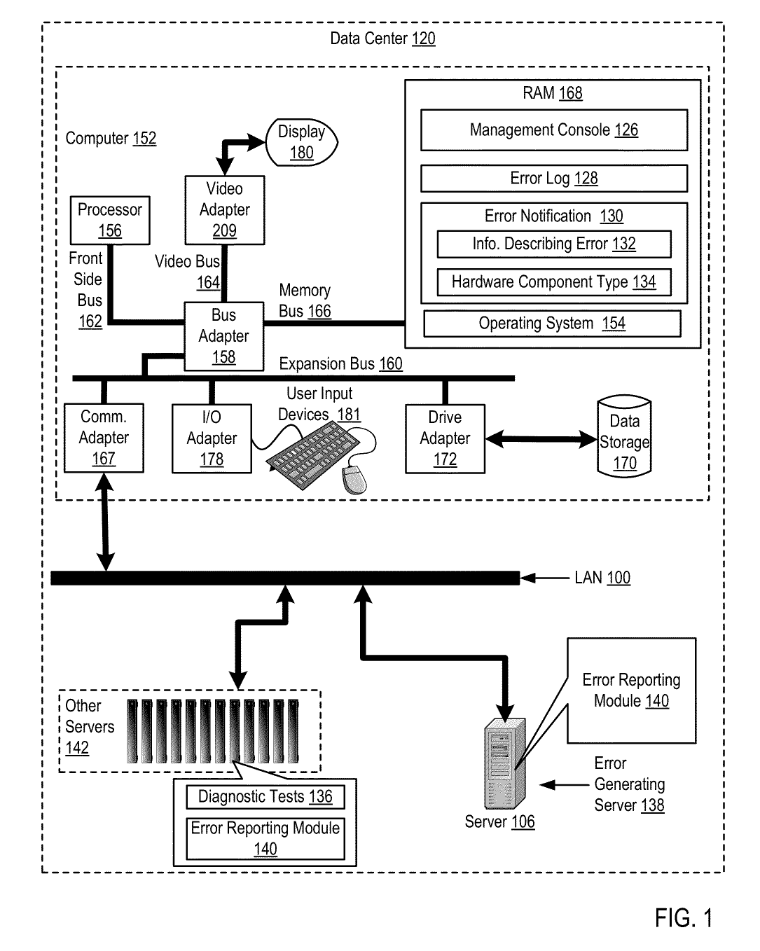

Exemplary methods, apparatus, and products for performing diagnostic tests in a data center in accordance with the present invention are described with reference to the accompanying drawings, beginning with FIG. 1. FIG. 1 sets forth a block diagram of a system for performing diagnostic tests in a data center according to embodiments of the present invention. The system of FIG. 1 includes a data center (120) refers to a facility used to house computer systems and associated components, such as telecommunications and storage systems. A data center generally includes redundant or backup power supplies, redundant data communications connections, environmental controls (e.g., air conditioning, fire suppression) and security devices.

The data center (120) in the example of FIG. 1 includes several examples of automated computing machinery configured to perform diagnostic tests in a data center according to embodiments of the present invention including a computer (152), a server (106), and other servers (142). The servers (106, 142) include two or more different types of servers. A server's ‘type’ refers to the components and configuration of the server. For example, one type of server may include an x86 processor, DDR3 RAM, a PCI express card, a Solid State drive (‘SSD’), and so on.

Each server (106, 142) in the example of FIG. 1 includes an error reporting module (140) configured to report errors to a management console (126) in an error log format specific to the type of the server reporting the error log. That is, servers of different types may report errors in different formats to a management console.

The computer (152) of FIG. 1 includes at least one computer processor (156) or ‘CPU’ as well as random access memory (168) (‘RAM’) which is connected through a high speed memory bus (166) and a bus adapter (158) to a processor (156) and to other components of the computer (152).

Stored in RAM (168) is a management console (126), a module of computer program instructions that, when executed by the processor (156), cause the computer (152) to carry out diagnostic testing in the data center (120) according to embodiments of the present invention. The management console (126) is configured to receive, from an error generating server (138), an error log (128) indicating an error produced by a hardware component of the error generating server. The management console (126) is also configured to parse the error log into an error notification (138) that includes information (132) describing the error and a type (134) of the hardware component producing the error in the error generating server. The management console (126) may be configured to parse a variety of error log formats as the data center includes a variety of server types each of which may be configured to provide an error log in a different format. The management console then provides, to a plurality of other servers (142), the error notification (140).

Each of the other servers (142) that receives the error notification determines whether the server includes a hardware component having the same hardware component type (134) included in the error notification (130). If the server (142) includes a hardware component having the same hardware component type (134) included in the error notification, the server (142) performs one or more diagnostic tests (136) on the hardware component of the server and reports results of the diagnostic tests (140) to the management console. In this way, the management console may gather diagnostic information (test results) from a plurality of sources quickly, upon a first error, rather than waiting for many servers to experience and report a similar error before analyzing error reports.

Also stored in RAM (168) is an operating system (154). Operating systems useful in computers that perform diagnostic tests in a data center according to embodiments of the present invention include UNIX™, Linux™, Microsoft XP™, AIX™, IBM's i5/OS™, and others as will occur to those of skill in the art. The operating system (154), management console (126), error log (128), and error notification in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers that perform diagnostic tests in a data center according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers, such as the servers (142, 106) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers that perform diagnostic tests in a data center according to embodiments of the present invention include modems for wired dial-up communications, Ethernet (IEEE 802.3) adapters for wired data communications, and 802.11 adapters for wireless data communications.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

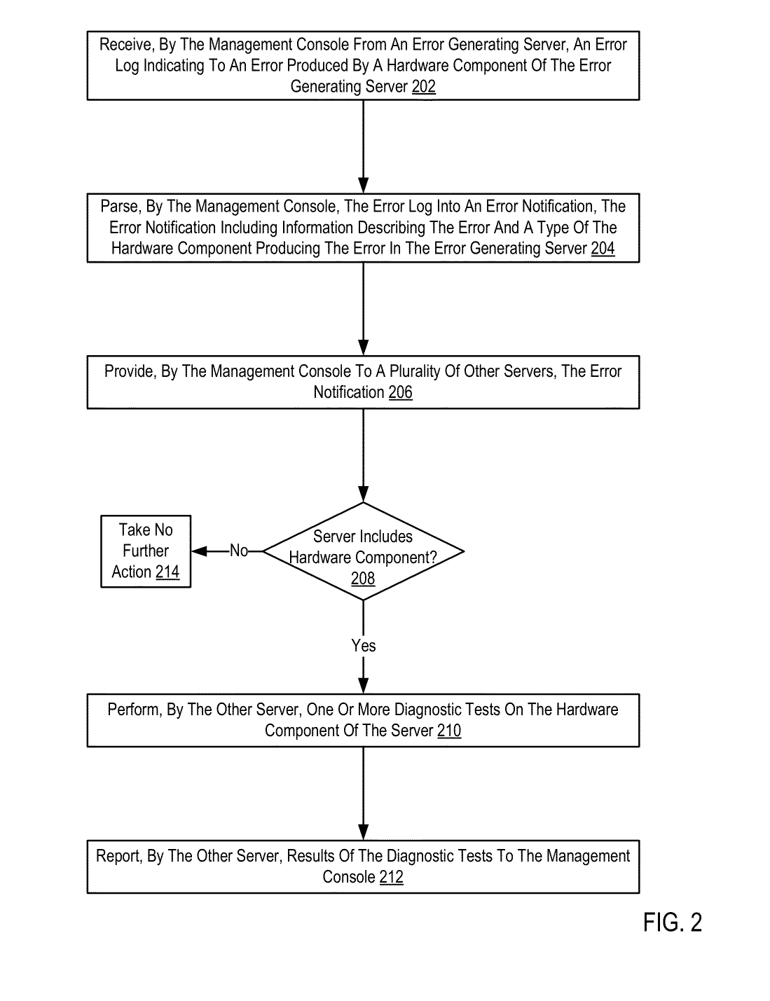

For further explanation, FIG. 2 sets forth a flow chart illustrating an exemplary method for performing diagnostic tests in a data center according to embodiments of the present invention. The method of FIG. 2 may be carried out in a data center similar to the data center depicted in the example of FIG. 1. Such a data center may include a plurality of servers and a management console. The plurality of servers may include two or more different types of servers. Each server may be configured to report errors to the management console in an error log format specific to the type of the server reporting the error log.

The method of FIG. 2 includes receiving (202), by the management console from an error generating server, an error log indicating an error produced by a hardware component of the error generating server. Receiving (202) an error log indicating an error produced by a hardware component of the error generating server may be carried out in various ways including, for example, by receiving one or more data communications messages via a data communications network, where the messages contain, as a payload, error log information. In some embodiments, the management console may receive such messages at a TCP/IP port, or the like, designated for the purposes of receiving error logs. The error log may contains various information including, for example, a description of the error, operating characteristics at the time the error occurred, identification and version information of software or firmware executing on the server or hardware component generating the error, test cases run by the server (or a service processor of the server) prior to the generation of the error, hardware components and configuration of the server, and other information as will occur to readers of skill in the art.

The method of FIG. 2 also includes parsing (204), by the management console, the error log into an error notification, the error notification including information describing the error and a type of the hardware component producing the error in the error generating server. As mentioned above, error logs may be generated in various formats including, for example, comma delimited text, eXtensible Markup Language (‘XML’), HTML, or some other predefined format. Parsing (204) the error log into an error notification then includes identifying the type of format of the error log and retrieving information from the error log in dependence upon the format. The management console may identify the type of the error log format by identifying the type of the server generating the format. The management console may then retrieve information from the error log in accordance with rules specifying information to retrieve in dependence upon the format of the error log.

The method of FIG. 2 also includes providing (204), by the management console to a plurality of other servers, the error notification. Providing (204) the error notification to a plurality of servers may be carried out in various ways. In some embodiments, the servers may execute a module of computer program instructions configured to receive such notifications as application-level data communications messages transmitted via a data communications network. In some embodiments, the servers may employ a service processor, implemented either as part of the motherboard of the server dedicated to the server as part of a server chassis containing a set of servers. In such embodiments, the management console may provide the notification to the service processor (such as a baseboard management controller) out-of-band via an out-of-band communications link such as an Inter-Integrated Circuit (‘I²C’) bus, Shared Management Bus (‘SMbus’), or the like.

For each of the other servers receiving the error notification, the method of FIG. 2 continues by determining (208), by the other server, whether the server includes a hardware component having the same hardware component type included in the error notification. If the server does not include the hardware component having the same hardware component type, the server in the example of FIG. 2 takes (214) no further action. Readers of skill in the art will recognize that taking (214) no action is but one embodiment among many possible embodiments. In other embodiments, upon a server determining that the server does not include the same hardware component type included in the error notification, the server may report the lack of the hardware component to the management console.

If the other server includes a hardware component having the same hardware component type included in the error notification, the method of FIG. 2 continues by performing (210), by the other server, one or more diagnostic tests on the hardware component of the server and reporting (212), by the other server, results of the diagnostic tests to the management console. In some embodiments, each server may be preconfigured with a set of diagnostics tests that the server runs upon receiving an error notification that includes an identification of a hardware component type also included in the server.

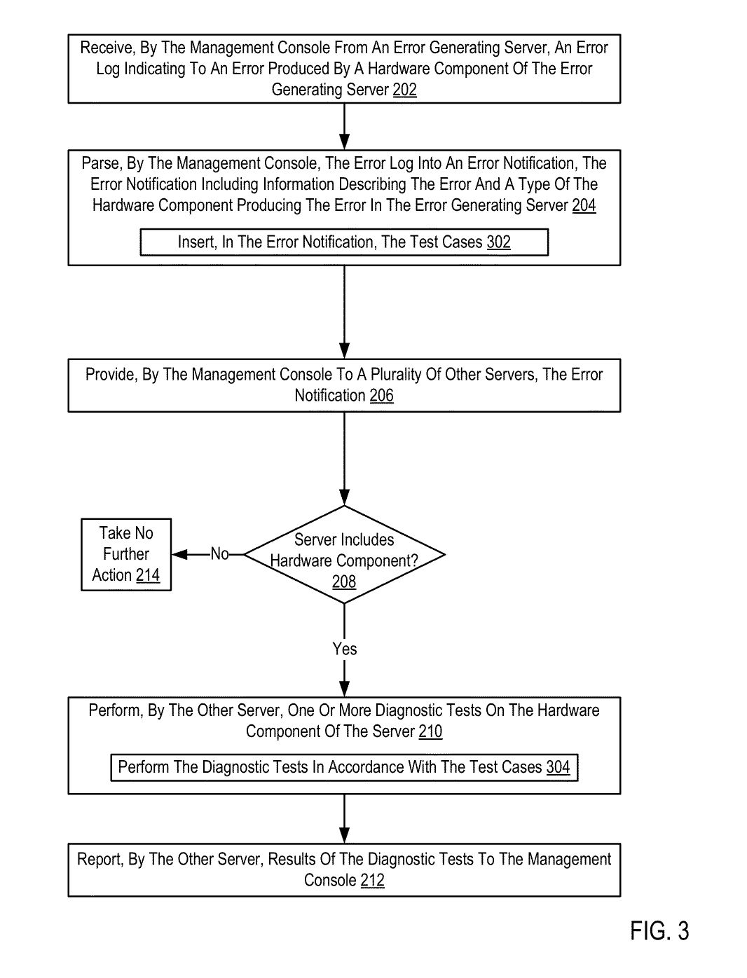

For further explanation, FIG. 3 sets forth a flow chart illustrating a further exemplary method for performing diagnostic tests in a data center according to embodiments of the present invention. The method of FIG. 3 is similar to the method of FIG. 2 in that the method of FIG. 3 is also carried out in data center that includes a plurality of servers and a management console, where the servers include two or more different types and each server is configured to report errors to the management console in an error log format specific to the type of the server reporting the error log. The method of FIG. 3 is also similar to the method of FIG. 2 in that the method of FIG. 3 includes receiving (202) an error log; parsing (204) the error log into an error notification; providing (206) the error notification to a plurality of other servers; and for each of the other servers receiving the error notification: determining (208) whether the server includes a hardware component having the same hardware component type included in the error notification. If the other server includes a hardware component having the same hardware component type included in the error notification, the method of FIG. 3 includes performing (210) one or more diagnostic tests on the hardware component of the server and reporting (212) results to the management console.

The method of FIG. 3 differs from the method of FIG. 2, however, in the error log also includes one or more test cases executed on the error generating server prior to the hardware component of the error generating server producing the error. A test case as the term is used here refers to a set of operating parameters, configuration parameters, actions carried out by the server, or the like. Consider, for example, that the hardware component generating an error is a fan. One test case may be an operating parameter of “Max speed,” while another may be “50% speed.” Test cases provide some insight into a possible causes of the error.

In the method of FIG. 3, parsing (204) the error log into an error notification also includes inserting (302), in the error notification, the test cases. Thus, when the management console provides the error notification to the other servers, the management console also provides the test cases.

To that end, performing (210) one or more diagnostic tests on the hardware component of the server in the example of FIG. 3 also includes performing (304) the diagnostic tests in accordance with the test cases. In this way, the management console may, without user assistance, initiate diagnostic tests on a number of servers that have the same hardware component under similar if not identical conditions as those experienced by the server generating the error.

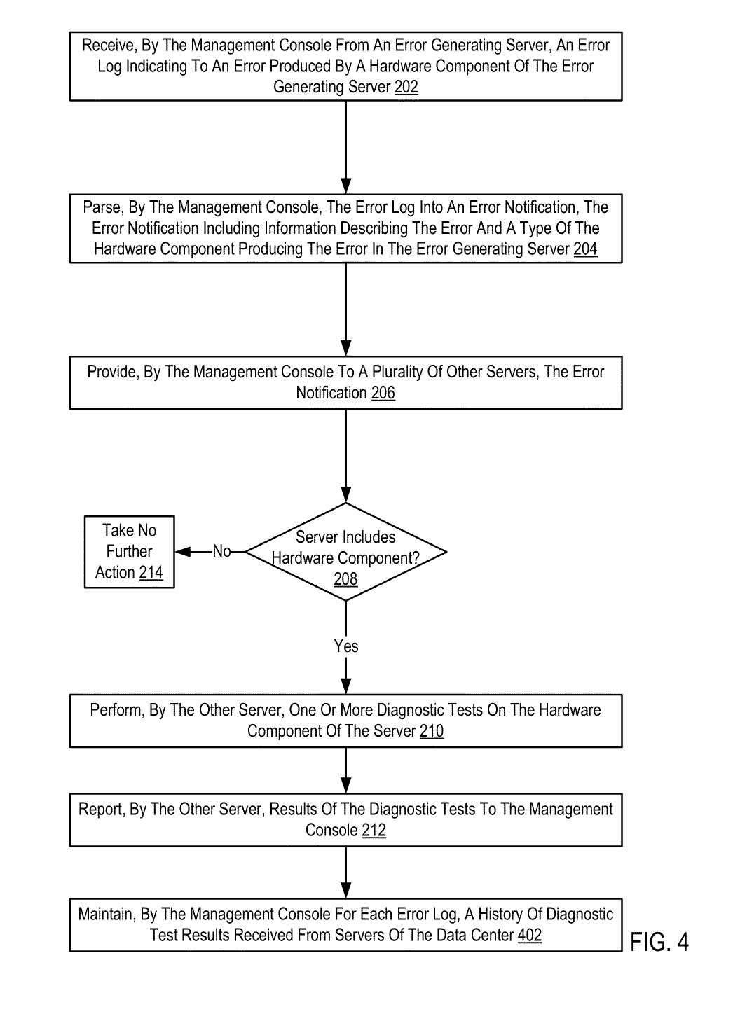

For further explanation, FIG. 4 sets forth a flow chart illustrating a further exemplary method for performing diagnostic tests in a data center according to embodiments of the present invention. The method of FIG. 4 is similar to the method of FIG. 2 in that the method of FIG. 4 is also carried out in data center that includes a plurality of servers and a management console, where the servers include two or more different types and each server is configured to report errors to the management console in an error log format specific to the type of the server reporting the error log. The method of FIG. 4 is also similar to the method of FIG. 2 in that the method of FIG. 4 includes receiving (202) an error log; parsing (204) the error log into an error notification; providing (206) the error notification to a plurality of other servers; and for each of the other servers receiving the error notification: determining (208) whether the server includes a hardware component having the same hardware component type included in the error notification. If the other server includes a hardware component having the same hardware component type included in the error notification, the method of FIG. 4 includes performing (210) one or more diagnostic tests on the hardware component of the server and reporting (212) results to the management console.

The method of FIG. 4 differs from the method of FIG. 2, however, in that the method of FIG. 4 includes maintaining (402), by the management console for each error log, a history of diagnostic test results received from servers of the data center. While some mitigating actions may be performed automatically without user interaction (as described below in greater detail) the method of FIG. 4 includes maintaining a history of diagnostic test results to that a user or system administrator may analyze the test results. Although a system administrator analyzes the results of the diagnostic tests, the system administrator need not initiate the tests themselves or wait until multiple error of the same or similar type are generated across numerous servers. Instead, upon receiving a first error log identifying a hardware component error, the management console initiates diagnostic tests on numerous servers automatically, without user interaction and without the need to wait for future error logs of a similar type.

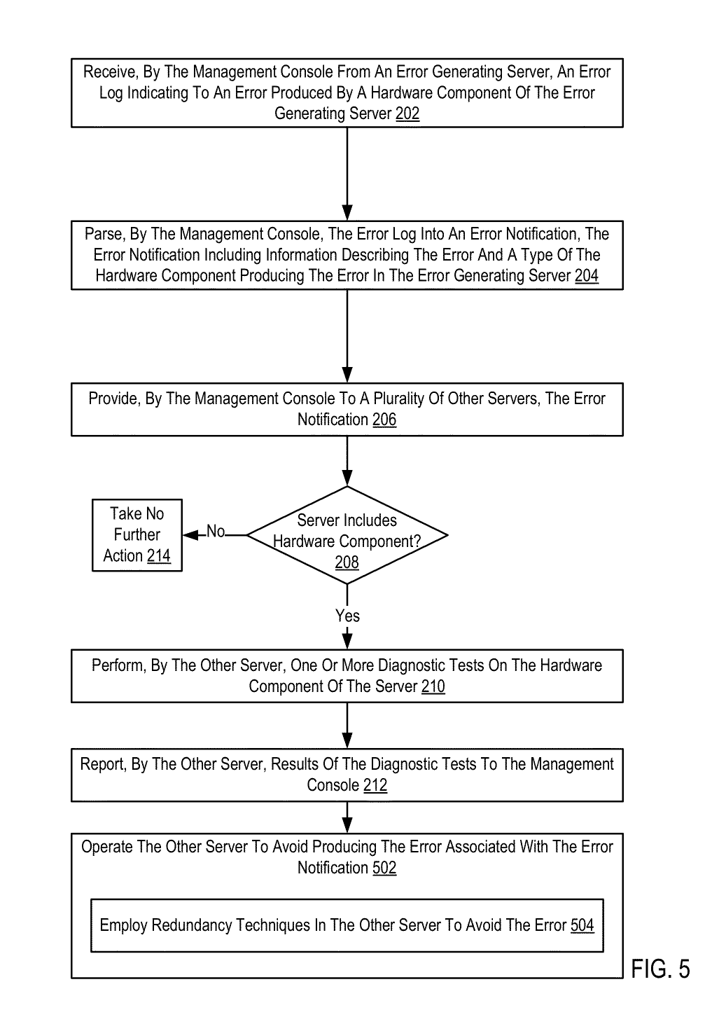

For further explanation, FIG. 5 sets forth a flow chart illustrating a further exemplary method for performing diagnostic tests in a data center according to embodiments of the present invention. The method of FIG. 5 is similar to the method of FIG. 2 in that the method of FIG. 5 is also carried out in data center that includes a plurality of servers and a management console, where the servers include two or more different types and each server is configured to report errors to the management console in an error log format specific to the type of the server reporting the error log. The method of FIG. 5 is also similar to the method of FIG. 2 in that the method of FIG. 5 includes receiving (202) an error log; parsing (204) the error log into an error notification; providing (206) the error notification to a plurality of other servers; and for each of the other servers receiving the error notification: determining (208) whether the server includes a hardware component having the same hardware component type included in the error notification. If the other server includes a hardware component having the same hardware component type included in the error notification, the method of FIG. 5 includes performing (210) one or more diagnostic tests on the hardware component of the server and reporting (212) results to the management console.

The method of FIG. 5 differs from the method of FIG. 2, however, in that the method of FIG. 5 includes, upon a server performing (210) the diagnostic tests and reporting (212) the results, operating (502) the other server to avoid producing the error associated with the error notification. Consider another example in which the error generating server reports in the error log that the fan produces an error when run above 85% speed. Servers having a similar fan may operate in a manner where the fan speed is never increased to 85% and may reduce heat generation by employing other tactics, such as throttling, core hopping, redistributing workload to other servers, and so on.

In some embodiments, the error log may also include a pattern of system changes just prior to the error including any combination of hardware modifications (installations, removals, change in configuration), software installations and removals, firmware updates or rollbacks, and the like. A server having a similar configuration may operate in manner so as to avoid the same pattern of system changes. If multiple servers provide similar error logs with similar patterns, the management console may be configured to provide, in the error notification, some indication that the pattern is more likely to cause the error.

Operating (502) the other server to avoid producing the error associated with the error notification in the method of FIG. 5 may also include employing redundancy techniques in the other server to avoid the error. Consider, for example that the error generating server reports in the error log a memory error within a hypervisor's memory space. Servers having a similar memory area and hypervisor configuration may activate Selective Memory Mirroring (SMM), a memory redundancy mode.

Operating (502) the other server to avoid producing the error associated with the error notification in the method of FIG. 5 may also include avoiding a pattern of usage of a hardware component. That is, an error log may indicate information on a pattern of usage of the hardware component causing the error and in response to the error notification, other servers may be operated to avoid producing the error by avoiding the pattern of usage indicated in the error log. For example, if a failure is observed in a fan after certain specific steps of a system, these steps may be stored as part of the error log. Upon feeding this error log into other systems, the corresponding steps can be avoided in other systems. If multiple systems demonstrate a similar pattern, then the weightage for this pattern may be increased and can be considered as a valid test case.

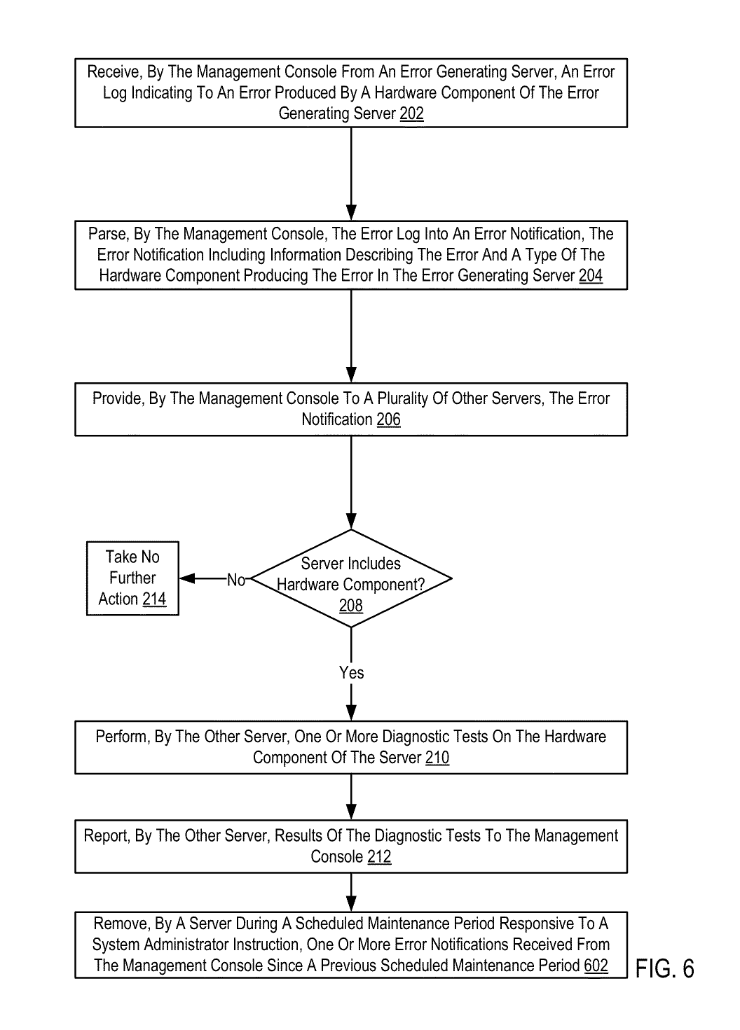

For further explanation, FIG. 6 sets forth a flow chart illustrating a further exemplary method for performing diagnostic tests in a data center according to embodiments of the present invention. The method of FIG. 6 is similar to the method of FIG. 2 in that the method of FIG. 6 is also carried out in data center that includes a plurality of servers and a management console, where the servers include two or more different types and each server is configured to report errors to the management console in an error log format specific to the type of the server reporting the error log. The method of FIG. 6 is also similar to the method of FIG. 2 in that the method of FIG. 6 includes receiving (202) an error log; parsing (204) the error log into an error notification; providing (206) the error notification to a plurality of other servers; and for each of the other servers receiving the error notification: determining (208) whether the server includes a hardware component having the same hardware component type included in the error notification. If the other server includes a hardware component having the same hardware component type included in the error notification, the method of FIG. 6 includes performing (210) one or more diagnostic tests on the hardware component of the server and reporting (212) results to the management console.

The method of FIG. 6 differs from the method of FIG. 2, however, in that the method of FIG. 6 also includes removing, by a server responsive to a system administrator instruction during a scheduled maintenance period, one or more error notifications received from the management console since a previous scheduled maintenance period. Consider, for example, that a server has a same hardware component type as that indicated in an error notification. As such, the server performs diagnostic tests, reports the results, and operates in a manner so as to avoid producing the error. Consider further that the hardware component in the error generating server is failed, while the hardware component in the other server has not and will not produce the error under normal circumstances. As such, operating the server in a manner to avoid producing the error may be inefficient and unnecessary. To that end, the method of FIG. 6 provides a means by which a server may clear a history of error notifications, enabling the server to operate at full capacity.

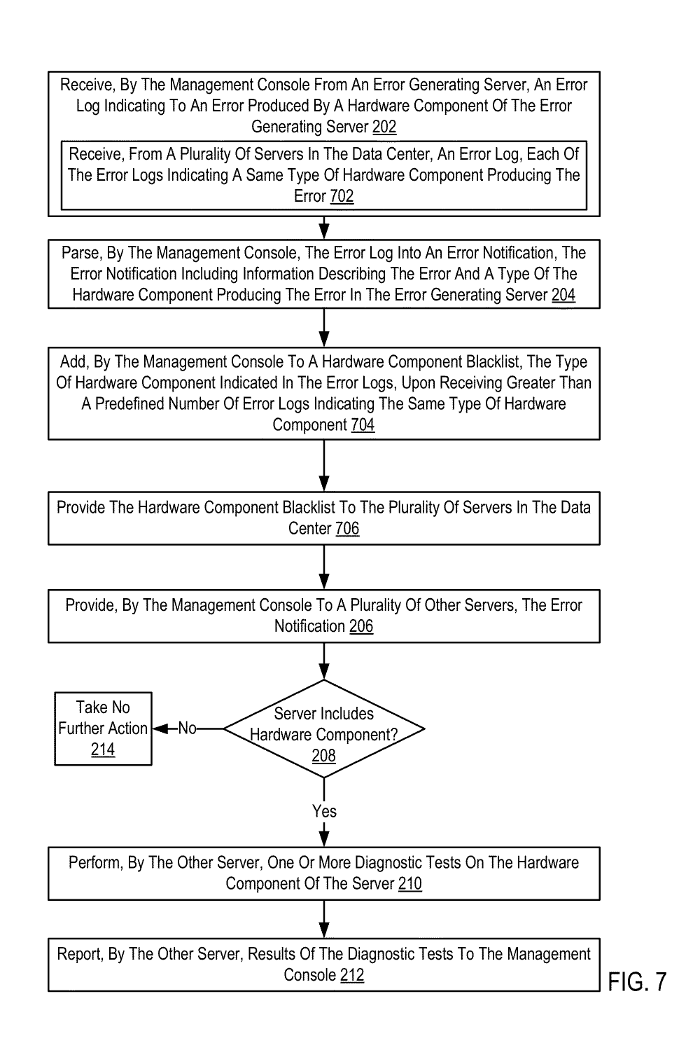

For further explanation, FIG. 7 sets forth a flow chart illustrating a further exemplary method for performing diagnostic tests in a data center according to embodiments of the present invention. The method of FIG. 7 is similar to the method of FIG. 2 in that the method of FIG. 7 is also carried out in data center that includes a plurality of servers and a management console, where the servers include two or more different types and each server is configured to report errors to the management console in an error log format specific to the type of the server reporting the error log. The method of FIG. 7 is also similar to the method of FIG. 2 in that the method of FIG. 7 includes receiving (202) an error log; parsing (204) the error log into an error notification; providing (206) the error notification to a plurality of other servers; and for each of the other servers receiving the error notification: determining (208) whether the server includes a hardware component having the same hardware component type included in the error notification. If the other server includes a hardware component having the same hardware component type included in the error notification, the method of FIG. 7 includes performing (210) one or more diagnostic tests on the hardware component of the server and reporting (212) results to the management console.

The method of FIG. 7 differs from the method of FIG. 2, however, in that in the method of FIG. 7, receiving (202) an error log includes receiving (702), from a plurality of servers in the data center, an error log, each of the error logs indicating a same type of hardware component producing the error. Upon receiving greater than a predefined number of error logs indicating the same type of hardware component, the method of FIG. 7 continues by adding (704), by the management console to a hardware component blacklist, the type of hardware component indicated in the error logs and providing (206) the hardware component blacklist to the plurality of servers in the data center. The hardware component blacklist is a list of hardware components, in some embodiments listed by part number, that indicate hardware components known to produce errors. Such a blacklist may be utilized in various ways by the servers, by users, and by system administrators. A server receiving the blacklist may in some embodiments and when possible cease utilizing the blacklisted hardware component. System administrators may be informed through a notification from the server that a blacklisted hardware component is included in the server and removal or replacement of the component may be necessary. Upon establishment of a cloud environment that includes a server having a blacklisted hardware component, the management console may notify the user establishing the cloud environment. Readers will understand that these are but a few of many possible actions that may be carried out responsive to the blacklist of hardware components. Each possible action is well within the scope of the present invention.

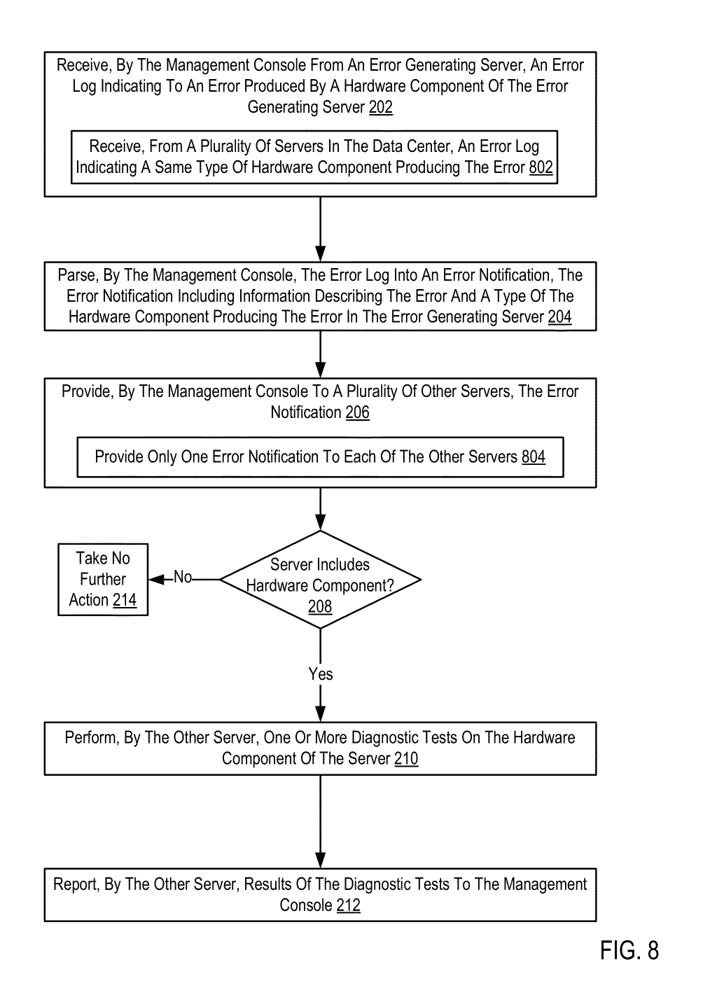

For further explanation, FIG. 8 sets forth a flow chart illustrating a further exemplary method for performing diagnostic tests in a data center according to embodiments of the present invention. The method of FIG. 8 is similar to the method of FIG. 2 in that the method of FIG. 8 is also carried out in data center that includes a plurality of servers and a management console, where the servers include two or more different types and each server is configured to report errors to the management console in an error log format specific to the type of the server reporting the error log. The method of FIG. 8 is also similar to the method of FIG. 2 in that the method of FIG. 8 includes receiving (202) an error log; parsing (204) the error log into an error notification; providing (206) the error notification to a plurality of other servers; and for each of the other servers receiving the error notification: determining (208) whether the server includes a hardware component having the same hardware component type included in the error notification. If the other server includes a hardware component having the same hardware component type included in the error notification, the method of FIG. 8 includes performing (210) one or more diagnostic tests on the hardware component of the server and reporting (212) results to the management console.

The method of FIG. 8 differs from the method of FIG. 2, however, in the method of FIG. 8 receiving (202) an error log includes receiving (802), from a plurality of servers in the data center, an error log indicating a same type of hardware component producing the error. Also in the method of FIG. 8, providing (206) the error notification to the plurality of other servers includes providing (804) only one error notification to each of the other servers. That is, rather than flooding the network, service processors, or servers with one notification for each of the plurality of error logs, the management console may be configured to send only one error notification for the entire set of error logs.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1-9. (canceled)

10. An apparatus for performing diagnostic tests in a data center, the data center comprising a plurality of servers and a management console, the plurality of servers comprising two or more different types of servers, each server configured to report errors to the management console in an error log format specific to the type of the server reporting the error log, the apparatus comprising a computer processor, a computer memory operatively coupled to the computer processor, the computer memory having disposed within it computer program instructions that, when executed by the computer processor, cause the apparatus to carry out the steps of:
receiving, by the management console from an error generating server, an error log indicating an error produced by a hardware component of the error generating server;
parsing, by the management console, the error log into an error notification, the error notification including information describing the error and a type of the hardware component producing the error in the error generating server; and
providing, by the management console to a plurality of other servers, the error notification.

11. The apparatus of claim 10 further comprising computer program instructions that, when executed by the computer processor, cause the apparatus to carry out the steps of:
for each of the other servers receiving the error notification:
determining, by the other server, whether the server includes a hardware component having the same hardware component type included in the error notification;
if the other server includes a hardware component having the same hardware component type included in the error notification:
performing, by the other server, one or more diagnostic tests on the hardware component of the server; and
reporting, by the other server, results of the diagnostic tests to the management console.

12. The apparatus of claim 11 wherein:
the error log further comprises one or more test cases executed on the error generating server prior to the hardware component of the error generating server producing the error;
parsing the error log into an error notification further comprises inserting, in the error notification, the test cases; and
performing, by the other server, one or more diagnostic tests on the hardware component of the server further comprises performing the diagnostic tests in accordance with the test cases.

13. The apparatus of claim 11 further comprising computer program instructions that, when executed by the computer processor, cause the apparatus to carry out the step of maintaining, by the management console for each error log, a history of diagnostic test results received from servers of the data center.

14. The apparatus of claim 10 further comprising computer program instructions that, when executed by the computer processor, cause the apparatus to carry out the step of operating the other server to avoid producing the error associated with the error notification if the other server includes a hardware component having the same hardware component type included in the error notification.

15. The apparatus of claim 14 wherein operating the other server to avoid producing the error associated with the error notification further comprises employing redundancy techniques in the other server to avoid the error.

16. The apparatus of claim 14 wherein the error log indicates information on a pattern of usage of the hardware component causing the error; wherein the other server is operated to avoid producing the error by avoiding the pattern of usage indicated in the error log.

17. The apparatus of claim 10 wherein receiving an error log further comprises receiving, from a plurality of servers in the data center, an error log, each of the error logs indicating a same type of hardware component producing the error, and the apparatus further comprises computer program instructions that, when executed by the computer processor, cause the apparatus to carry out the steps of:
upon receiving greater than a predefined number of error logs indicating the same type of hardware component, adding, by the management console to a hardware component blacklist, the type of hardware component indicated in the error logs; and
providing the hardware component blacklist to the plurality of servers in the data center.

18. The apparatus of claim 10 wherein:
receiving an error log further comprises receiving, from a plurality of servers in the data center, an error log indicating a same type of hardware component producing the error; and
providing the error notification to the plurality of other servers further comprises providing only one error notification to each of the other servers.

19. A computer program product for performing diagnostic tests in a data center, the data center comprising a plurality of servers and a management console, the plurality of servers comprising two or more different types of servers, each server configured to report errors to the management console in an error log format specific to the type of the server reporting the error log, the computer program product disposed upon a computer readable medium, the computer program product comprising computer program instructions that, when executed, cause a computer to carry out the steps of:
receiving, by the management console from an error generating server, an error log indicating an error produced by a hardware component of the error generating server;
parsing, by the management console, the error log into an error notification, the error notification including information describing the error and a type of the hardware component producing the error in the error generating server; and
providing, by the management console to a plurality of other servers, the error notification.

20. The computer program product of claim 19 further comprising computer program instructions that, when executed, cause the computer to carry out the steps of:
for each of the other servers receiving the error notification:
determining, by the other server, whether the server includes a hardware component having the same hardware component type included in the error notification;
if the other server includes a hardware component having the same hardware component type included in the error notification:
performing, by the other server, one or more diagnostic tests on the hardware component of the server; and
reporting, by the other server, results of the diagnostic tests to the management console.
